(19) United States
(12) Patent Application Publication
(10) Pub. No.: US 2021/0241751 A1
(43) Pub. Date: Aug. 5, 2021

(54) SPATIALLY GLOBAL NOISE CANCELLATION

(71) Applicant: TECHNION RESEARCH AND DEVELOPMET FOUNDATION LIMITED, Haifa (IL)

(72) Inventor: Beni CUKUREL, Kibbutz Nahsholim (IL)

(21) Appl. No.: 17/050,509

(22) PCT Filed: Apr. 18, 2019
(86) PCT No.: PCT/IL2019/050452

§ 371 Date: Oct. 26, 2020

(30) Foreign Application Priority Data
Apr. 25, 2018 (IL) 258943

(51) Int. Cl. G10K 15/04; G10K 11/178; H04R 23/00

(52) U.S. Cl. CPC G10K 15/04; G10K 11/1781; G10K 11/17857; G10K 2210/3229; H04R 23/002; G10K 2210/1281; G10K 11/17873

(57) ABSTRACT

Systems and methods for the reduction of noise arising from the fluid mechanics of the aerodynamic interactions of the relative motion of solid elements with a fluid, generally air, by generating pressure fields at or close to the source of the aerodynamic noise, these pressure fields having amplitudes and frequencies equivalent to those of the noise fields to be reduced, but phases opposite thereto. These generated pressure fields globally cancel the effect of the noise fields and this affect is propagated into the far field. Use is made of planar electro-thermal transducers, transforming a periodically fluctuating heat flux generated by Joule AC heating into an acoustic wave. The frequency, amplitude and phase of the noise field may be detected by microphones positioned close to points of generation of the noise field, such that the cancellation is effective over the same region as the noise field propagates.

### FIELD OF THE INVENTION

The present invention relates to the field of the cancellation of noise by means of electrically driven thermo-acoustic transducers, especially using techniques which are effective over a wider region other than a specific local region.

### BACKGROUND

Noise reduction via sound cancellation is a trending mechanism for diminishing acoustic pollution in a multitude of sectors, including aviation, energy generation, transportation, military applications and elsewhere. Such systems use local annihilation of an unwanted acoustic pressure field through the creation of an out-of-phase sound wave at the same amplitude and frequency, actively modulated in a control circuit according to the unwanted sounds as detected by sensing elements. This typically involves an array of loudspeakers, which convert electric power into acoustic energy through vibro-mechanics. This solution works well in a limited number of clearly localized and defined situations, but the geometric limitations of conventional loudspeakers prevent the effective use of these anti-phase pressure emitters from being used in a distributed manner. Therefore, the common implementation of prior art noise cancellation is generally localized to the observer, rather than providing an overall elimination or reduction at the source. Moreover, due to the moving parts, the inherently fragile design of vibro-mechanical devices like loudspeakers, even if of the more robust types such as ribbon speakers or electrostatic speakers, prevents their efficient deployment and utilization in most industrial or large scale environmental applications.

Furthermore, besides the above mentioned problems of the localized nature of the acoustic cancellation, a nd the fragility of some of the sources available, conventional speaker technologies produce sound via vibro-acoustics. The most common electrodynamic speakers operate by the relative linear motion between a permanent magnet and a coil type electro-magnet connected to a diaphragm. Electrostatic loudspeakers are made up of a thin positively charged diaphragm sandwiched between two metallic meshes of opposing charge, the polarity of which is periodically inverted. Ribbon transducers make use of a thin metal ribbon suspended in a magnetic field, which vibrates when an oscillatory electrical signal is applied on it. Magnetostrictive technology is based on shape change of some metal during magnetization, inducing vibrations. Piezoelectric speakers, which produce sound by changing dimensions when subject to a potential difference, have been used in aviation noise cancellation applications. Thus, in all these acoustic sources, sound is produced by moving components which require a free volume on both sides of the vibrating element. This forced the earlier applications to cut open windows inside stators, to place the actuators within, and to close the surface by metallic covers and porous meshes. Common to all vibro-acoustic sources is this inherent need to design for unrestricted openings that allow diaphragm movement. Such an approach cannot be readily implemented on flying platforms or on the moving surfaces of machinery.

One of the most important fields where noise reduction is of great importance, involves the reduction of noise pollution around airports. This applies to both take-off and landing aircraft, and reference is made to FIG. 1, which shows the comparative levels of noise from the various sources in an aircraft. These sounds are produced from a number of sources, including blade-pass interactions between the rotors and stators of a multi-stage engine, separation points, vortex wake interactions, large scale turbulence, boundary layer radiation and shockwaves. Strong sounds are also generated at or close to the surfaces of the airframe, especially at the leading and trailing edges of airfoils and flaps. Control of noise generated by aircraft surfaces, however, is generally secondary to those generated by the engines. Such noises typically pose substantial challenges due to extreme operational conditions and environments, complex component geometry, highly complex surface interactions, and perhaps most important, the distributed nature of the noise sources, which cannot be readily cancelled on a non-localized basis.

Modern commercial aircraft employ high-bypass-ratio (HBPR) engines with separate hot and cold flow paths, and non-mixing, short-duct exhaust systems. The noise sources in such engine are the turbine, the compressor, the jet and the fan. The contribution of each noise source has significantly evolved in the last decades. In designs typical of the 1960s, the jet was the main source of noise, whereas in modern turbofans, the fan itself is the main noise source.

Considering the jet itself, the noise is generated largely due to the high-speed, high-temperature, and high-pressure nature of the exhaust, especially during high thrust conditions. One major source of jet noise is the turbulent mixing of shear layers in the engine's exhaust. These shear layers contain instabilities that lead to highly turbulent vortices that generate the pressure fluctuations responsible for the sound. In order to reduce the noise associated with jet flow, various technologies have been developed to disrupt shear layer turbulence and reduce the overall noise produced.

Noise reduction of the jet engine plume signature can be achieved by the use of chevrons, or saw tooth patterns on the trailing edges of jet engine nozzles. Their principle of operation is that, as hot air from the engine core mixes with cooler air blowing through the engine fan, the shaped edges serve to smooth the mixing, which reduces noise-creating turbulence. This technology was developed largely by NASA Glenn Research Center, and is reviewed in the article by K.B.M.Q. Zaman et al, entitled “Evolution from ‘Tabs’ to ‘Chevron Technology’—a Review”, published in Int. J. of Aeroacoustics, pp. 47-63 (October 2011), publishing the Proceedings of the 13th Asian Congress of Fluid Mechanics, 2010, Dhaka, Bangladesh. DOI: 10.1260/1475-472X.10.5-6.685

Considering the fan, its noise is mostly tonal and its signature depends on the fan rotational speed:

at low speed, the fan noise is due to the interaction of the blades with the distorted flow injected in the engine; this happens for example during the approach;
at high engine ratings, the fan tip is supersonic and this allows intense rotor-locked duct modes to propagate upstream. This noise, known as “buzz saw”, is typical at take-off, and is described in the article entitled “Buzz-saw noise: prediction of the rotor-alone pressure field” by A. McAlpine, et al, published in Journal of Sound and Vibration, 331(22), 4901-4918, (2012). DOI: 10.1016/j.jsv.2012.06.009.

A number of solutions have been proposed for reducing engine noise on aircraft, including:

1. Passive acoustic liners to damp the noise generated. These are installed in the nacelle, and they extend as much as possible to cover the largest area.
2. Aircraft reconfiguration (engines located above the wings deflect sound upwards)
3. Blade/component optimization for minimum noise production
4. Active noise control via loudspeaker arrays
5. Periodic blade pitch change (ROTOSUB™, as available from RotoSub AB of Linkoping, Sweden)

However, each of these proposed solutions has significant drawbacks, as follows:
1. Passive acoustic liners only reduce sound produced at a single frequency associated with the tonal content of a specific operating point, and are therefore less useful for dynamic or broader range of operating conditions such as in take-off and landing situations.
2. Aircraft reconfiguration may be feasible, but is unlikely to occur because of the huge expenses and risk in making such a fundamental change in aircraft design.
3. Component optimization of the rotor/stator shapes does not fully eliminate the problem, and in any event, it has a negative impact on performance and efficiency, both of which are generally considered much more important than noise reduction.
4. Loudspeaker array systems are heavy and complex, and in any event, cannot operate in the high temperatures of a jet engine environment.
5. ROTOSUB™ technology may be effective, but is impractical for highly loaded airfoil applications, such as on the rotors of an aircraft engine.

Rotary fans, whether a small fan in a desktop computer, or the fan of a large GT engine, generate most of their noise through aerodynamics associated with rotor-stator interaction. Such noise must be distinguished from vibro-acoustic interactions, in which mechanical vibrations generate propagating sound waves in the air contacting the vibrating element. In contrast to vibro-acoustic noise, most fan noise arises from the fluid mechanics of aerodynamic interactions, between the moving mechanical parts of the fan (the rotor) cutting through the fluid surrounding those parts. The layers of air are periodically sheared by the rotating blades of the fan, generating coherent vortex structures in the fluid flow stream. Additionally, the flow of the fluid propelled by the rotor is temporally and spatially non-uniform, and such a flow past the stators contributes to significant sound from the interaction of the fluid with the stator blades as well. Since such noise sources are located over the entire circular periphery of the rotor and the stator blades, any sources for noise cancellation should also be located around this periphery, so that effective cancellation of the noise field can be achieved globally over a large space, regardless of observer positions, extending out to the far field. The prior art methods of using loudspeakers is unable to tackle this problem, since the size of the loudspeakers, even if substantially miniaturized, does not enable them to be positioned at the source of the fluid dynamic interaction which generates the noise, and any other location would render the solution sensitive to the position of the observer, or more accurately, the sound perceiver.

The previously mentioned FIG. 1 illustrates the breakdown of the various noise components of a complete aircraft, comparing the take-off characteristic noise breakdown, with that of the approach noise. As is observed, the vast majority of the noise comes from engine noise and not from airframe generated noise.

Reference is now made to FIG. 2, which illustrates the various noise sources in a modern gas turbine engine, as a function of the frequency of spectrum. As is observed, the level of jet noise falls off rapidly with increasing frequency, such that over the majority of the disturbing noise spectrum, the major contribution to the noise comes from distinct frequencies associated with the fan.

Other rotating machinery systems that generate noise almost entirely from fluid dynamics interactions, include such installations as ventilation fans, electronic equipment cooling fans, air conditioning units, wind turbines, printing presses (where noise is generated by the regular flutter of the moving sheets being transported through the press), vacuum cleaners, and other such devices. Additionally, machinery with exhaust and intake manifolds and ducts, such as internal combustion engine intake and exhaust passages, vacuum cleaners and air conditioning installations also generate such noise from the high speed flow of air through them. Finally, moving vehicles and aircraft also generate such noise by the motion of the vehicle or aircraft (airframe, wings or landing gear) through the ambient air.

A number of prior art references describe the use of sound cancellation techniques for reducing noise pollution from various airborne related sources. Thus, in US Application No. 2013/0056581 to D. Sparks, for “Rijke tube cancellation device for helicopters”, there is described an acoustic signature reduction system for application typically on an aircraft. The acoustic signature reduction system uses a controller, power supply, and a thermo-acoustic tube such as a Rijke tube or Sondhauss tube to generate a cancellation noise of equal amplitude and inverted phase to that of noise generated by rotor blades when rotating. However, such thermo-acoustic tube sources are bulky and lengthy, as shown in FIG. 1 of the reference, since they generate the sound wave by the thermo-acoustic interaction within a gas. Thus, although this reference describes the use of thermo-acoustic gas tubes to reduce the noise of the helicopter rotor, it does not appear to be practical to use them as distributed acoustic sources for noise cancelation within gas turbine or jet engines, or on any other moving parts, where their physical dimensions would interfere with the operation of the device.

In U.S. Pat. No. 5,478,199, for “Active Low Noise Fan Assembly” to P. R. Gliebe, there is described a turbo fan engine in which the fundamental blade passing frequency noise tone is actively attenuated by a plurality of anti-noise sound transmitters disposed in the fan duct. The only sound transmitters specifically described in this reference are electromagnetic sound drivers or speakers, or piezoelectric ceramic drivers, or fluidic drivers, all of which involve moving parts, and therefore, need a free volume to enable the propagation of the sound from the device.

In U.S. Pat. No. 9,442,496, for “Active Airborne Noise Abatement” and in US Published Patent Application No. 2017/0178618 for “Carbon Nanotube Transducers on Propeller Blades for Sound Control”, both to B. C. Beckman et al., there are described the use, inter alia, of carbon nano-tubes or piezoelectric sound transducers for sound cancellation of the predicted sound patterns of helicopter blades.

In general, due to the moving parts involved in vibro-mechanical devices of the prior art, not only does their miniaturization presents significant challenges, but they are inherently fragile and require clearance gaps around the vibrating diaphragm boundaries and thus not suitable for aero-engine and the general airframe environment.

Furthermore, because of the large spatial volume over which such noises are propagated, prior art solutions of noise cancellation have limited effectiveness, and therefore, there exists a need for sound reduction systems which overcome at least some of the disadvantages of prior art systems and methods of reducing aero-dynamically generated noise.

The disclosures of each of the publications mentioned in this section and in other sections of the specification, are hereby incorporated by reference, each in its entirety.

### SUMMARY

The present disclosure describes new exemplary systems and methods for the reduction of noise arising from the fluid mechanics of the aerodynamic interactions of high speed relative motion between a fluid, generally air, and a solid element, whether the relative motion is generated by high speed motion of rotor blades through the fluid, or whether from the high speed temporally and spatially non-uniform, anisotropic flow of the fluid past static elements such as stator blades. Such systems and methods operate by generating pressure fields at or close to the source of the aerodynamic noise, these pressure fields having amplitudes and frequencies equivalent to those of the noise fields intended to be reduced, but phases opposite thereto. As a result, these generated pressure fields globally cancel the effect of the noise fields and this affect is propagated in to the far field. These new systems utilize sound generating devices in the form of thermo-acoustic devices, which are essentially planar electro-thermal sound transducers, transforming a periodically fluctuating heat flux into an acoustic wave. If the heating is generated by AC Joule heating, such as by using a sinusoidal input current, the frequency of the periodically fluctuating heat source, and thus the sound wave, is twice the frequency of the AC voltage input, as the heat dissipation of the thermo-acoustic device is dependent on the absolute value of the input signal, and therefore provides a heat pulse on both the positive and negative half-periods of the AC input current.

Such devices, known historically as thermophones, have the advantage that they can be constructed in the form of thin, large area elements, such that they can be applied to surfaces very close to or even at the regions of the noise generating aerodynamic interactions. In this respect, they are able to cancel the aerodynamic noises essentially at source, and therefore are effective over essentially the same spatial volume over which the noise itself propagates. Such systems therefore present a global solution to the problem of noise generation and propagation by aerodynamic interactions, which cannot be achieved by the use of loudspeakers. Loudspeakers, by virtue of their size and structure, can only be positioned in the general vicinity of the noise source and cannot be located on surfaces very close to the regions of the noise generating aerodynamic interactions, or even co-planar to the elements in those regions causing the noise generation. An additional advantageous feature which enables the use of such thermo-acoustic generators in achieving noise cancellation in the field of the aerodynamic interaction of fast relative motion of objects with their surrounding fluid, especially in gas turbines, is that they can be constructed very robustly, such that they can withstand the extreme environmental conditions of the engine.

In order to cancel the acoustic noise field, it is necessary to determine its frequency, amplitude and phase, such that the cancellation field can be generated accordingly. One method of doing this is by means of active noise estimation, based on the use of microphones positioned throughout the region of noise field generation, and the input of the microphone output signals in a feedback control loop to drive the thermo-acoustic generators. Such methods have been used in prior art noise cancellation schemes using loudspeakers, but the systems described in the present disclosure differ in that they enable an effective cancellation field over the source boundary, which globally diminishes noise also at the far field.

An alternative method for determining the cancellation field parameters, is by use of what will be termed in this disclosure as a predictive cancellation scheme. This scheme is based on the prediction of noise levels from either acoustic simulation or from prior measurements on the rotating system, and the generation of dynamic cancellation fields which are phase locked to the rotation speed and relative rotor-stator positions. The relative phase can be calculated a priori for each different rotor blade at each relative position as it passes the stator based on the total number of blades and rotational speed. The advantage of this method is that there is no need to position microphones in a jet engine, which could be problematic because of the harsh conditions present there. Furthermore, there will be no reduction in the efficiency of the engine, which may be otherwise reduced by the presence of an array of even tiny microphones and their associated wiring.

The same considerations apply to the cancellation of noise fields arising from the interaction of fast moving aircraft or other vehicular surfaces with the surrounding atmosphere. Here too, a number of factors combine to make the use of prior art loudspeaker compensation fields impractical, namely that (i) there are extreme operating environments, (ii) it is of great importance not to affect the geometry of the flight or aerodynamic surfaces, (iii) the surface interactions with the atmosphere are complex, and (iv) the noise sources are distributed over large areas. The use of planar thermo-acoustic interaction devices also enables efficient noise reduction especially when considering the above mentioned combination of factors.

It is to be understood that when terms such as opposite phase, or in antiphase, or out of phase, and the like are used in this disclosure, and thuswise claimed, the intention is to a sound wave that is optimally 180° out of phase with the wave it is intended to cancel, but that minor variations from this exact out-of-phase situation which may occur, are also intended to be included in this designation. The important characterizing feature is that such terms are intended to encompasses all frequencies which are conducive to global destructive interference between the noise source and the cancelling thermophone signal.

Furthermore, although the sound fields, the reduction of which the methods and systems of the present application are directed to, may arise from any kind of high speed relative motion between a fluid and solid elements located in the fluid flow, whether elements moving or rotating at high speed through an essentially static fluid, or whether fluid flowing at high speed past essentially static elements, or whether the relative motion of the fluid with respect to the element is temporally and spatially non-uniform, or any situation in-between, the currently disclosed methods and systems are often described in this disclosure in terms of rotating rotors in their surrounding fluid environment, since this is the most commonly held conception of such noise sources. However, even when this situation is thus used in illustrating the current methods and systems, it is to be understood that the methods and systems are not intended to be limited only to fast solid element motion through a fluid, but should be interpreted as fast relative motion between the solid element and its surrounding fluid, whether it be steady or unsteady, and uniform or non-uniform.

There is thus provided in accordance with an exemplary implementation of the devices described in this disclosure, a system for the reduction over a spatial volume, of a noise field arising from an aerodynamic interaction of an element having relative motion with its surrounding fluid, the system comprising:

(i) at least one microphone disposed on the element or in close proximity thereto, the at least one microphone adapted to produce an output signal corresponding to the noise field arising from interaction of the element with its surrounding fluid,
(ii) at least one planar thermo-acoustic generator having an electrically powered heating layer disposed on the element, or in close proximity thereto, and
(iii) a control unit adapted to utilize the output signal of the at least one microphone, and to generate current correlated to the output signal for application to the electrically powered heating layer, such that the at least one thermo-acoustic generator emits a compensating noise field having the frequencies and amplitudes of that measured by the at least one microphone, but having an opposite phase, such that the noise field is reduced over the spatial volume.

In such a system, the relative motion may arise either from motion of the element through the fluid, or from motion of the fluid past the element, or from a combination thereof. In such a case, the relative motion of the fluid with respect to the element may be temporally or spatially non-uniform motion.

In any of the above mentioned systems, the element maybe a rotating element. In such a situation, the rotating element may at least be one blade of a fan or a compressor or a turbine. Alternatively, the rotating element may be a component of a jet engine. In the latter case, the aerodynamic interaction may be generated by the motion of the air resulting from interaction of a rotor and stator of the jet engine.

According to yet further implementations, the at least one thermo-acoustic generator may comprise a planar substrate on which is deposited an electrically powered heating layer. Furthermore, the at least one thermo-acoustic generator may be disposed on at least one of the stator and rotor of a fan. Alternatively, the at least one thermo-acoustic generator, may be disposed on at least one of the surfaces of a wind turbine, or on at least one of the stator and rotor of the compressor of a jet engine. Furthermore, the at least one thermo-acoustic generator may be disposed on at least one of the surfaces of a ground vehicle or an aerial vehicle. Also, in any of the above described systems, the surrounding fluid may itself be affected by other stationary or moving elements.

According to yet another exemplary implementation of the systems described above, the controller may be configured to spectrally analyze the noise field, and to generate from spectral components of the noise field, waveforms of current for applying to at least one thermo-acoustic generator, having frequency, amplitude and phase such that the spectral components of the compensating noise field emitted by the thermo-acoustic generator neutralize the spectral components of the noise field.

According to yet further implementations of the present application, there is provided a system for the reduction over a spatial volume, of a noise field arising from an aerodynamic interaction of an element with its surrounding fluid, the system comprising:

(i) at least one planar thermo-acoustic generator having an electrically powered heating layer disposed on the element or in close proximity thereto, and
(ii) a control unit adapted to generate a current correlated to the noise field for application to the electrically powered heating layer, such that the at least one thermo-acoustic generator emits a compensating noise field having the frequencies and amplitudes of the noise field, but having opposite phase, such that the noise field is reduced over the spatial volume, wherein the frequencies, amplitudes and phases of the noise field are predicted either by a simulation of the noise field as a function of the position and speed of motion of a moving element associated with the flow of the fluid, or by a set of prior measurements of the noise field as a function of the position and speed of motion of the moving element.

In such a system, the motion of the moving element may be either a rotation or a displacement motion. The moving element may be any of a piston, a diaphragm, a rotor, or a valve. It may alternatively be a part of the rotor of a rotor-stator mechanism, and the current may then be phase locked to the relative rotor-stator position and the speed of rotation. Yet alternatively, the moving element may be at least one blade of a fan or a compressor or a turbine, or a component of a jet engine. In the latter case, the aerodynamic interaction may be generated by the motion of the air resulting from interaction of a rotor and stator of the jet engine.

In any of the latter mentioned systems, the at least one thermo-acoustic generator may comprise a substrate on which is disposed a thin, electrically powered heating element. The at least one thermo-acoustic generator may be disposed on at least one of the stator and rotor of a fan or a compressor or a turbine, or on at least one of the surfaces of a wind turbine, or at least one of the surfaces of a ground vehicle or an aerial vehicle.

Additionally, the surrounding fluid may itself be affected by other stationary or moving elements.

Furthermore, in any of the above mentioned systems for use with predictive noise fields, the controller may be configured to spectrally analyze the predicted noise field, and to generate from spectral components of the predicted noise field, current waveforms for applying to the at least one thermo-acoustic generator, the current waveforms having frequency, amplitude and phase such that the spectral components of the compensating noise field emitted by the thermo-acoustic generator, neutralize the spectral components of the predicted noise field.

According to an implementation of the methods described in the present disclosure, there is also provided a method for the reduction over a spatial volume, of a noise field arising from an aerodynamic interaction of an element having relative motion with its surrounding fluid, said method comprising:

(i) providing at least one microphone previously disposed on the element or in close proximity thereto, the at least one microphone adapted to produce an output signal corresponding to the noise field arising from interaction of the element with its surrounding fluid;
(ii) providing at least one planar thermo-acoustic generator having an electrically powered heating layer, the at least one planar thermo-acoustic generator being disposed on the element, or in close proximity thereto;
(iii) generating a current correlated to the output signal of the at least one microphone; and
(iv) applying the current to the electrically powered heating layer, such that the at least one thermo-acoustic generator emits a compensating noise field having the frequencies and amplitudes of that measured by the at least one microphone, but having an opposite phase, such that the noise field is globally reduced over the spatial volume.

In such a method, the global reduction of the noise field may be attained because of the disposing of the at least one planar thermo-acoustic generator on the element, or in close proximity thereto. Alternatively, the global reduction of the noise field may be attained because of the disposing of the at least one planar thermo-acoustic generator close to the points of generation of the noise field.

According to yet another implementation of the methods described in the present disclosure, there is further provided a method for the reduction over a spatial volume, of a noise field arising from an aerodynamic interaction of an element having relative motion with its surrounding fluid, the method comprising:

(i) providing at least one microphone disposed on the element or in close proximity thereto, the at least one microphone adapted to produce an output signal corresponding to the noise field arising from interaction of the element with its surrounding fluid,
(ii) providing at least one planar thermo-acoustic generator having an electrically powered heating layer, disposed on the element, or in close proximity thereto,
(iii) generating a current correlated to the output signal of the at least one microphone, and
(iv) applying the current to the electrically powered heating layer, such that the at least one thermo-acoustic generator emits a compensating noise field having the frequencies and amplitudes of that measured by the at least one microphone, but having an opposite phase, such that the noise field is globally reduced over the spatial volume.

In such a method, the global reduction of the noise field may be attained because of the disposing of the at least one planar thermo-acoustic generator on the element, or in close proximity thereto. Alternatively, the global reduction of the noise field may be attained because of the disposing of the at least one planar thermo-acoustic generator close to the points of generation of the noise field.

### BRIEF DESCRIPTION OF THE DRAWINGS

The present invention will be understood and appreciated more fully from the following detailed description, taken in conjunction with the drawings in which:

FIG. 1 shows the comparative levels of noise from the various sources in an aircraft;

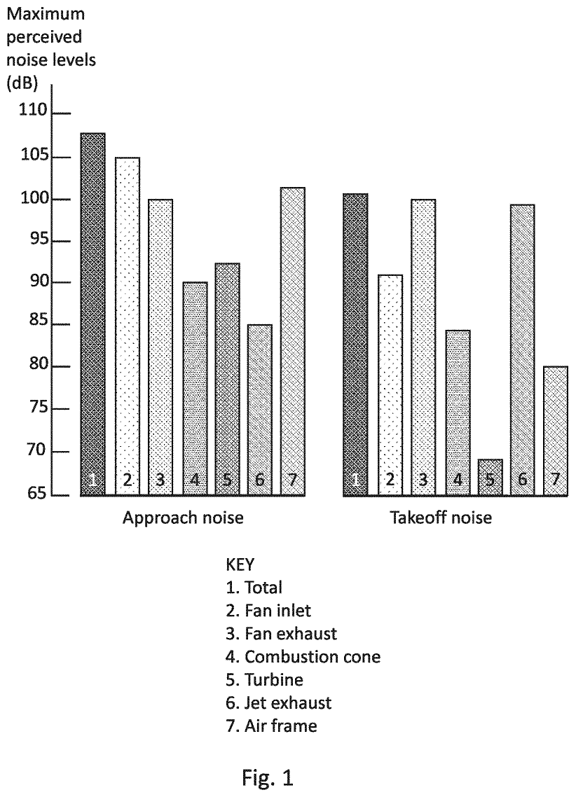

FIG. 2 is a graph illustrating the spectral breakdown of the various noise components of a complete aircraft;

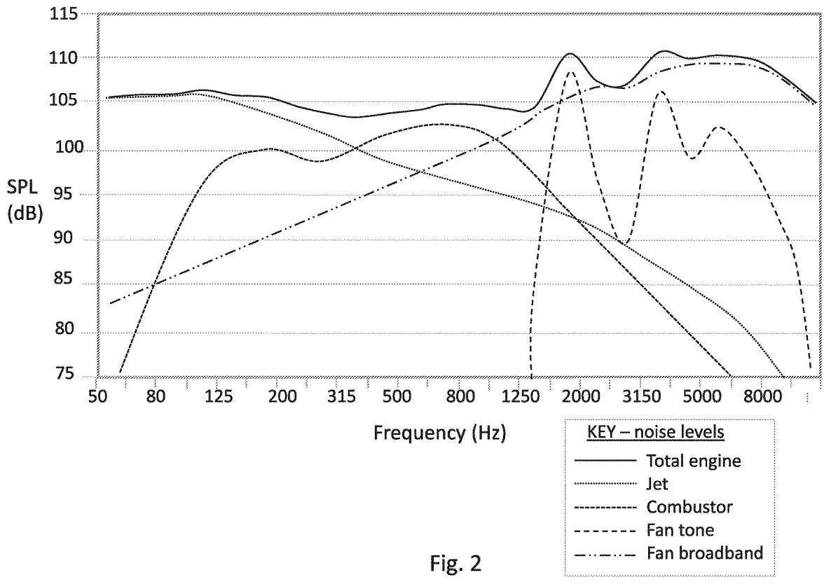

FIG. 3 shows schematically illustrates a representation of the generation of pressure fluctuations resulting from highly turbulent vortices generated by the interaction of two rotors and their respective stators in a multistage gas turbine engine;

FIG. 4 shows schematically an external loudspeaker prior art noise cancellation scheme;

FIG. 5 illustrates a simplified drawing of a thermo-acoustic interaction device, of the type used in implementing the systems of the present disclosure;

FIG. 6 shows a similar application to that solved by the prior art apparatus of FIG. 4, but illustrating the significant advantage of the novel systems using the thermo-acoustic interaction devices described in the present disclosure;

FIG. 7A shows a cutaway schematic drawing of a high bypass, turbo fan engine, showing where thermo-acoustic generator devices can be positioned to reduce fan noise levels, and FIG. 7B shows one exemplary method of construction and mounting of such a thermo-acoustic generator device on a blade of the engine of FIG. 7A;

FIG. 8 illustrates schematically how active noise cancellation is achieved in the example of the turbofan engine of FIG. 7A;

FIG. 9 shows schematically thermo-acoustic devices applied to various selected areas of the external panels of a motor vehicle, in order to cancel the wind noise;

FIG. 10 illustrates thermo-acoustic devices applied to external surfaces of a military aircraft, to reduce the flow noise generated by the air passing across these surfaces; and

FIG. 11 illustrates a configuration for predictive calculation of rotor-stator interaction noise in a turbojet engine.

### DETAILED DESCRIPTION

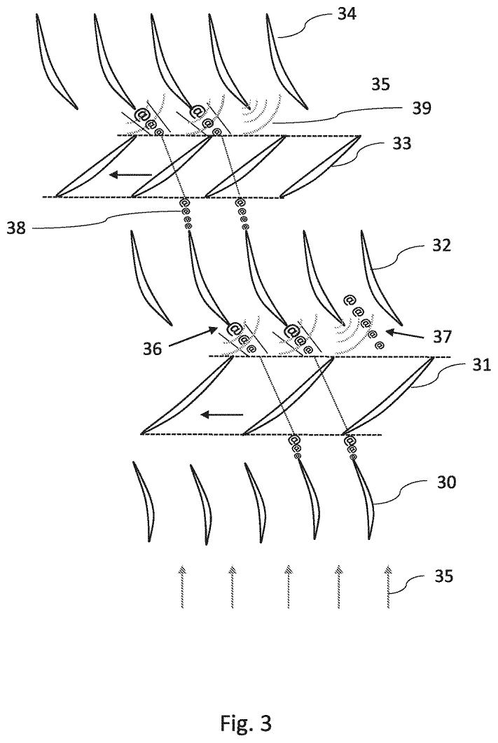

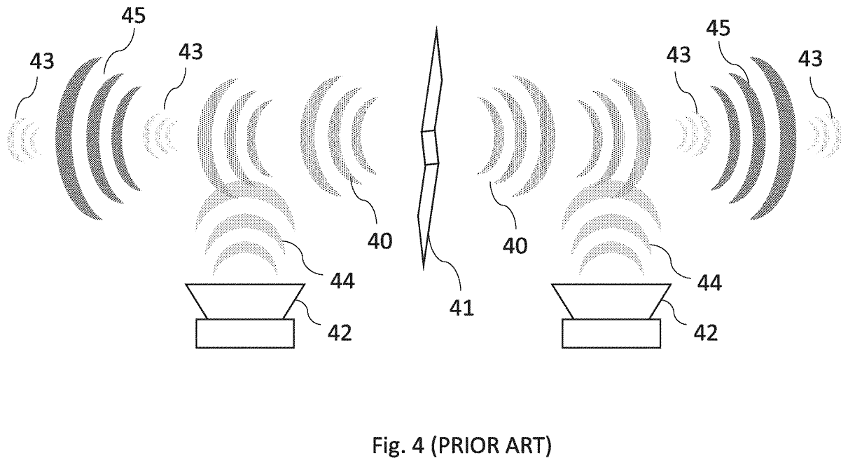

Reference is now made to FIGS. 3 and 4, which illustrate details of a typical exemplary source of the noise pollution which arise from aerodynamic interactions, and prior art active methods of combating such noise pollution. Reference is first made to FIG. 3, taken from an article by Marco Ernst, et al., of Aachen University, entitled “Analysis of Rotor-Stator-Interaction and Blade-to-Blade Measurements in a Two Stage Axial Flow Compressor” published by ASME in J. Turbomach 133(1), 011027 (Sep. 27, 2010) (12 pages). This drawing illustrates schematically a representation of the generation of pressure fluctuations resulting from highly turbulent vortices generated in the compressor stages of a multistage turbine engine. In FIG. 3, there is shown the air flow 35 entering the engine through the Inlet Guide Vanes (IGV) 30, and flowing through the first rotor 31, the first stator 32, the second rotor 33 and the second stator 34. Highly turbulent vortices 37, 38 are generated along the air stream through the compressor, with noise 39 resulting from the pressure fluctuations generated in several locations within the engine, mostly at the interaction points of each rotor blade with a stator blade which it passes, this resulting in either impingement 36 of the flow vortices with the leading edge of the next blade set, or lack of impingement 37, depending on the mutual and constantly changing positions of the next encountered leading edge. The resulting noise is produced from different phenomena such as blade-pass interaction between the stages, separation points, vortex wake interactions, large-scale turbulence, boundary layer radiation and shockwaves. Such a complex sound field configuration would be highly difficult to compensate for, using a local cancellation field externally applied by loudspeakers located remotely from the source positions, outside of the engine. The same considerations apply to airframe noise, generated at or close to moving surfaces, especially at the leading and trailing edges of airfoils. A particularly predominant source of noise is the flap-airfoil interaction, where highly turbulent motion is generated, this being substantially noticeable at landing approach.

Such a prior art external loudspeaker noise cancellation scheme is illustrated schematically in FIG. 4. The noise field 40 generated by a fan 41 is propagated in both directions upstream and downstream of the fan. Loudspeakers 42 are positioned outside of the fan, since such prior art sources cannot be positioned in the close proximity to the points of origin of the noise. The sound waves 44 which the loudspeakers generate interact with the noise field 40 generated by the fan, and the resultant output noise 43 should be at a reduced level compared with the original noise field 40. However, it should be clear that the ability to significantly cancel a complex noise field, such as that shown in FIG. 3, using discretely positioned sound sources, is very limited. Furthermore, since the location of the loudspeakers 42 is remote from the source of the noise field 41, the cancellation can only be effective over a limited set of predetermined positions where destructive interference takes place, leading to output noise 43 at a reduced level compared with the original noise filed 40. Outside of this small range of acoustic “fields of view”, the noise will not be cancelled, and moreover at specific other locations 45, may even be amplified due to constructive interference. Therefore, although this active prior art scheme may be effective for cancellation of noise in very specific locations resulting from a localized source, the cancellation effect will be very position dependent, and the prior art systems are thus ineffective in dealing with global environmental noise pollution such as that generated by a moving source such as an aircraft or a vehicle.

In contrast to the use of the prior art vibro-acoustic transducers remotely positioned relative to the position of the noise source, the devices described in this application, namely surface-deposited thermo-acoustic transducers, comprising a periodically heated electrically conductive thin layer, deposited directly on the noise source itself, addresses both of the shortcomings of the prior art cancellation systems shown hereinabove, namely (i) the ability to compensate for highly complex acoustic noise fields, and (ii) the ability to do so over a wide “field of view” space, such that the cancellation is generally effective no matter where the listening person is situated.

The structure of such heat flux transducers is simple and can be formed by conventional deposition techniques. Since the device is thin and its surface does not need to move mechanically in order to generate its output with respect to the application media, it can be deposited or attached to any surface in the vicinity of which the noise field is being generated. Such emitters do not create any macroscopic or microscopic mechanical motion during acoustic generation and create distortion-free sounds without any resonances that are characteristic to mechanical structures of vibrating elements. The sound is generated in the solid boundary at the solid-fluid interface, unlike conventional thermo-acoustic sources where the sound originates from the temperature-driven pressure gradients in the fluid, as in in Rijke tubes. Furthermore, the elements of the present application, neither take up significant space within the system in which they are installed nor increase the weight. They can also be constructed to withstand high temperatures. The above characteristics all point to their suitability for a wide range of applications, including turbomachinery, UAVs, drones, rotating systems, cars, wind turbines and printing mills.

Pressure field stimulation and sound production by means of Joule heating has been studied since the late 19th century. The term “thermophone” was coined two decades later, to define an acoustic transmitter capable of producing sound through high frequency thermal oscillations. Such thermo-acoustic interaction devices behave as electrical resistors, in which an alternating electrical current is converted to produce surface heat flux fluctuations and, consequently, pressure waves in the surrounding fluid, without requiring any mechanical motion. However, while there is no clear consensus in the literature as to the correct approach to modelling thermo-acoustic interaction device sound production, for the purposes of this disclosure, it is sufficient to describe such sound production as being electrically driven and capable of generating a spectral range of sounds, having both high and low frequencies. At the beginning of the present century, thermo-acoustic interaction devices regained the interest of the scientific community and advanced designs, such as suspended arrays of aluminum wires, carbon nanotubes, and graphene, were developed to explore the efficiency and performance envelopes of such heat flux sound sources. Moreover, significant efforts have been invested to characterize the impact of the deposition substrate, and thermo-acoustic device behavior in different gaseous and liquid media.

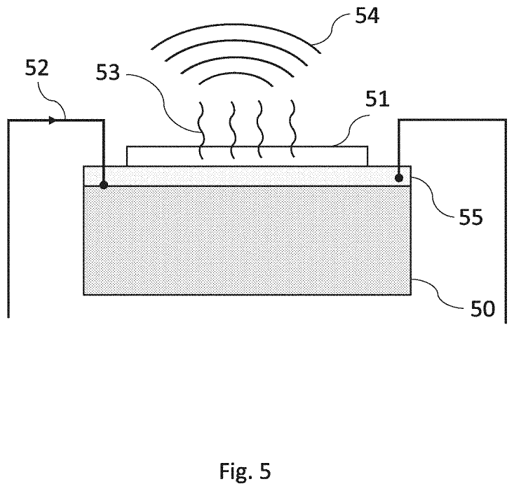

Reference is now made to FIG. 5, which illustrates a simplified drawing of such a thermo-acoustic device, of the type used in implementing the systems of the present disclosure, and showing schematically its component parts. The device is produced on a substrate 50 having a thin metallic heating element 51 deposited on its upper surface through which is passed the alternating electric current 52 to generate the desired oscillating heat fluxes 53 at the surface. These oscillating surface heat fluxes then generate acoustic waves 54, which are emitted from the surface. If a conducting substrate is used, a thin insulating layer 55 is formed on the surface of the substrate. The structure is simple and can be formed by conventional microelectronic techniques, or by any other suitable fabrication method. The device substrate should have as high a heat conduction as possible, since this feature enables the heating element to cool down rapidly as the AC drive current falls through its zero point, such that the amplitude of its temperature fluctuations should be as large as possible compared to its mean temperature. The thermal conduction characteristic of the substrate which should be maximized is the thermal effusivity, es, which is also known as the thermal product, and is given by the expression

es=κρCp,

where
κ is the thermal conductivity of the substrate,
ρ is the density, and
Cp is the specific heat capacity.

In addition, the thermo-acoustic interaction effect is generated only at the boundary between the substrate and the air, and the thermal condition of the deeper layers is thus only of secondary consequence to the effect of the thermo-acoustic interaction. Therefore, it is predominantly the boundary of the substrate which determines the thermal efficiency of the thermo-acoustic interaction. One particular property which has an effect on the thermo-acoustic effect is the atomic order of the surface layer, which has an important effect on the phonon transmission through the boundary. Along these lines, the thinner the substrate, the larger is the relative contribution of the ordered layer associated with ballistic phonon transfer with respect to the total phonon transfer across the heating element. Thus, for example, a liquid metal surface layer may be more efficient for use in this application than a solid metal substrate itself, since the liquid metal has a pool of electrons and phonons unbound to any structural imperfections which could be present in a solid metallic substrate. Such liquid metal surface layers are known, for instance, in a eutectic mixture of the metals gallium, indium, and tin, which can remain liquid down to −19° C. Such a mixture can be obtained as the commercial material known as “Galistan”, as supplied by Geraberger Thermometerwerk Gmbh of Geschwenda, Germany, and as described in U.S. Pat. No. 6,019,509, for “Low Melting Gallium, Indium, and Tin Eutectic Alloys, and Thermometers Employing Same”. Other similar compositions are also known. Such a substrate could be produced by depositing a thin layer of such a liquid alloy on the surface of a high thermal conductivity substrate, on which the liquid metal forms a tenacious layer because of the very high surface tension of the liquid alloy. The layer is so tenacious that it withstands removal by the fingers of a user or someone involved in the handling during assembly of the device. The positive and negative electrodes could be submerged into the liquid metal coating, which then serves as the heating element. In the scope of this disclosure, all references to solid thermophones can also be attributed to stationary liquid transducers held in place by viscous, capillary or electromagnetic forces.

The heating element itself should have an impedance equal to the source impedance of the AC power supply, if that is what is being used to drive the device, such that the energy transfer is optimal. The thinner the element, the higher its resistance, and therefore the higher the voltage required from the power supply to input a predetermined level of power.

Since the device is thin, it can be formed in large planar sheets, even flexible, and thus applied to any surface at which, or in the vicinity of which, the noise field is being generated. A particularly convenient construction could be in the form of layers of a thermo-acoustic device printed or assembled onto adhesive tapes which can be applied to the surfaces close to the source of the acoustic noise. There would then be need for a power supply connected to the applied tape, such as by means of a flexible flat cable connection.

Additionally, such devices, unlike prior art vibro-acoustic sources, not being dependent for the sound generation on any macroscopic mechanical motion, generate distortion-free sounds, without any resonances characteristic of the mechanical structure of a vibrating element. Furthermore, such elements do not require an opening in the structure on which they are mounted to enable their free vibrational motion, and therefore do not compromise the mechanical strength of the part on which they are mounted. Furthermore, they do not take up any significant space within the system in which they are installed nor increase the weight significantly. They can also be constructed to withstand high temperatures for use in those locations where such conditions exist. The above characteristics all point to their eminent suitability for application within rotating machinery such as fans and jet engines, or on the surfaces of vehicles or aircraft generating acoustic noise.

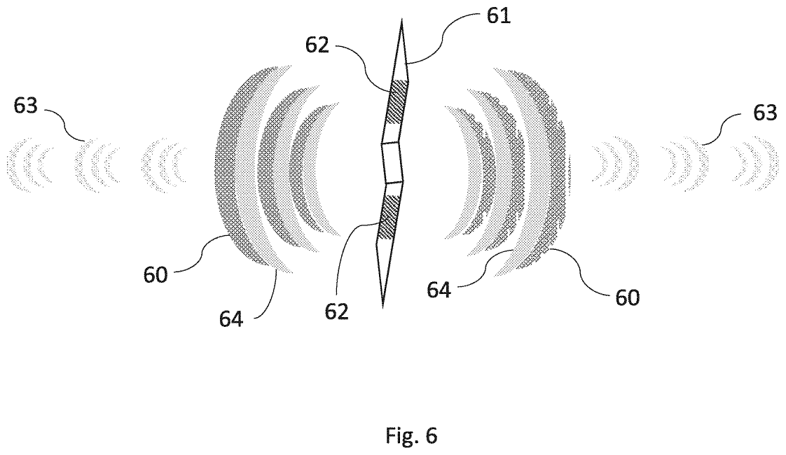

Reference is now made to FIG. 6, which shows a similar application to that solved by the prior art apparatus of FIG. 4, but illustrating the significant advantage of the novel systems described in the present disclosure. Similar to the situation in FIG. 4, in FIG. 6, there is shown a noise field 60 generated by a fan 61, being propagated in both directions upstream and downstream of the fan. However, unlike the situation of FIG. 4, in FIG. 6, thermo-acoustic generators 62 applied to the sound emitting elements of the fan 61, generate a compensation field 64 having the same amplitude and frequency as the noise emitted by the fan and emanated from the same source, but being in anti-phase to that noise, such that the noise field 60 of the fan is almost completely cancelled out, as shown by the small resultant field 63. Unlike the situation of FIG. 4 which uses remotely positioned loudspeakers, in FIG. 6, the compensation sound field is generated almost superposed on the noise sound field, such that the compensation is not only essentially complete, but also propagates with the propagating noise field, thereby providing its compensation effect globally over a large volumetric space.

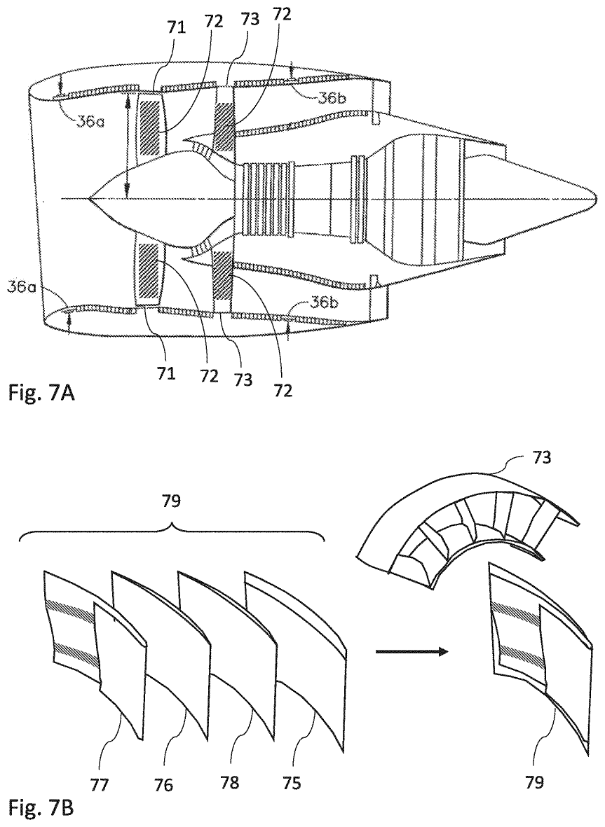

Reference is now made to FIG. 7A, which is a cutaway schematic drawing taken from the above mentioned U.S. Pat. No. 5,478,199 of a high bypass, turbo fan engine, showing the fan rotor 71, the fan stator 73, and the various compressor stages. According to the noise compensation configuration of the present disclosure, planar thermo-acoustic transducers 72 can be applied to any of the surfaces shown in the engine, such as on the rotor blades 71 of the fan, in which case the power may be supplied to the transducers through a slip ring, or the stator blades 73, in which case the power can be supplied to the transducers through hard wiring. In the prior art engine, the compensation sound sources 36a, 36b, are located in the inner wall of the fan duct, remote from the location of the sources of the noise at the fan rotor and stator blades, such that the compensation is expected to be approximate and spatially dependent.

Reference is now made to FIG. 7B, which illustrates schematically the structure of a thermo-acoustic layer 72 mounted on a surface profile 79 of such a stator 73, illustrating the ease with which a conformal configuration can be obtained with minimal disturbance to the functionality of the element on which it is mounted. The thermo-acoustic element itself is made up of the substrate 76, on which is formed the transducer itself 77, which is made up of the Joule heating current electrodes, and a protective cover layer. The thermo-acoustic element 76, 77 is bonded to the stator surface 75 by means of a bonding layer 78, such that it becomes a thin additional layer on the stator, without significantly interfering with the gas flow through the fan. The construction and materials can be made such that the thermo-acoustic layer withstands the temperatures expected at its location within the engine.

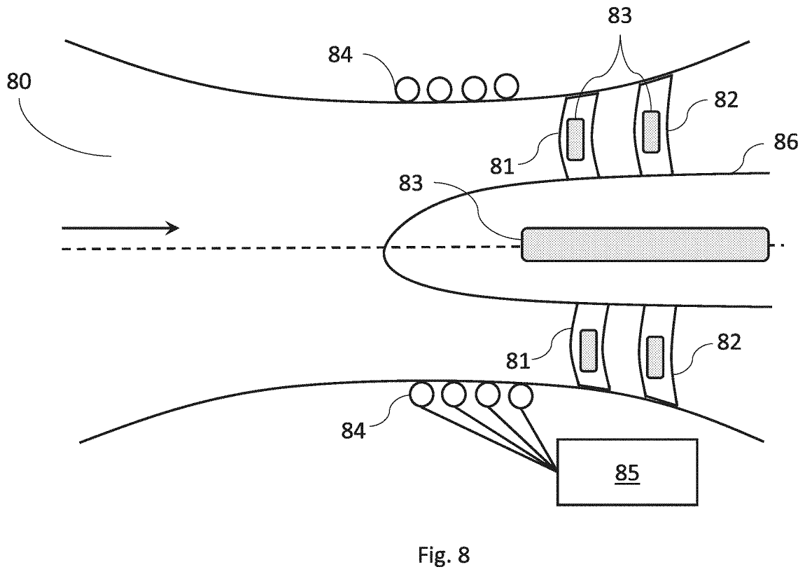

Reference is now made to FIG. 8, which illustrates schematically how the active noise cancellation is achieved in the example of the turbofan engine of FIG. 7. FIG. 8 is a schematic cross section of the inlet nacelle 80 and fan of such an engine, showing thermo-acoustic transducers 83 attached to rotor blades 81, stator blades 82 and the hub 86 of the inlet fan. The sounds generated by the inlet flow and from the fluid dynamic interaction of the rotating fan blades with the stator, are detected by the array of sensor microphones 84 which should be located close to the sources of the noise. The outputs of these sensor microphones are input to the system controller 85, where they are processed, and signals are distributed from the controller to the thermophones mounted in the engine to provide acoustic outputs which cancel as best as is possible, the noise generated by the flow and the fan. The microphones detect multi-tonal sounds, which must be converted by the controller 85 into current signals for driving the thermo-acoustic devices. The complex spectrum can be Fourier analyzed into its main spectral components, and each component may then be converted by the controller into a waveform containing a train of electric current pulses which should correspond to the temporally fluctuating heat flux train to be delivered to the thermo-acoustic device, for generating that component of the cancellation sound wave. The three important features of the temporal form of the current input waveform to the thermo-acoustic devices, for generating the temporally fluctuating heat flux, are that:

(i) the frequencies of the components of the electric current waveform input to the device should be the same as the frequencies of corresponding components of the tonal sound which it is desired to counterbalance;
(ii) in order to effect the noise cancellation itself, the controller should arrange that the phase of each component of the electric current waveform for generated the heating effects be opposite to that of the corresponding components of the sound waveform detected by the microphone; and
(iii) to ensure as complete cancellation as possible, the amplitude of each spectral component of the heating current should be controlled such that the sound generated by the device will be equal to that expected at the source position, either as directly measured by the microphone or as position-extrapolated by the microphone measurement, if the microphone is not close to the exact noise source.

As previously stated, if the Joule heating current supplied by the controller has a conventional AC sinusoidal voltage waveform without a DC component, i.e. a waveform generally symmetrical around the zero level, the classically understood voltage frequency of the sine wave should be half of the sound frequency which that spectral component of the noise that waveform is intended to cancel, since both the positive and the negative currents of the waveform generate successive heating pulses. This is analogous to the effect of a full-wave voltage rectification which generates successive positive pulses of output voltage relative to the zero voltage line, at twice the AC input frequency. On the other hand, if the controller is such as to supply heating current in the form of a series of positive-going current pulses, then the effective frequency of those pulses should be equal to the frequency of the sound wave component it is intended to cancel. In the scope of this disclosure, all references to correlated current imply a relation between the frequency and phase of the noise field and the current source.

The temporal position of the antiphase cancellation waveform is then determined by temporally positioning the heating waveform with its peaks at the same point of time as the troughs of the sound component waveform, and vice versa. It is to be understood that in any temporal determination of the phase of the input current waveform to the thermo-acoustic devices, there is to be taken into account any inherent phase delay that may be generated by the thermal characteristics of the device, between the current input itself and the resulting acoustic output from the device, such that it is the acoustic output waveform components that are in opposite phase to those of the noise waveform components which it is desired to cancel.

Such planar thermo-acoustic generators can be applied to other fan configurations, or other noise generating machinery, having less stringent environmental conditions than those expected within a turbojet engine, such as household fans or fans for electronic instrument cooling. They can also be used on wind turbines, for reducing the noise level of the turbine, applied either to the rotor blades, or to the gearbox, or to the tower of the turbine.

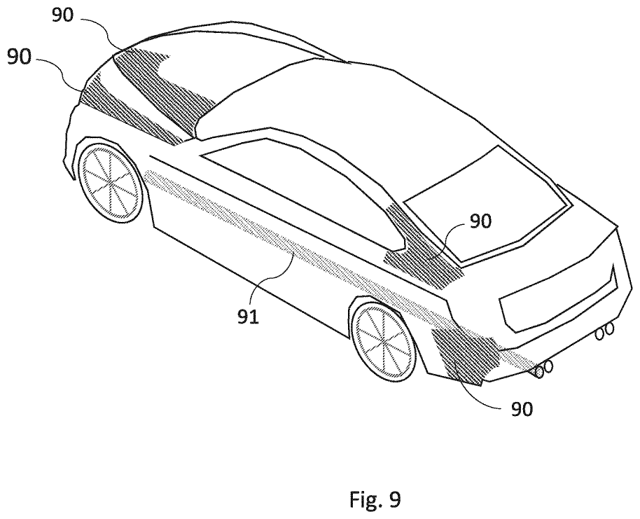

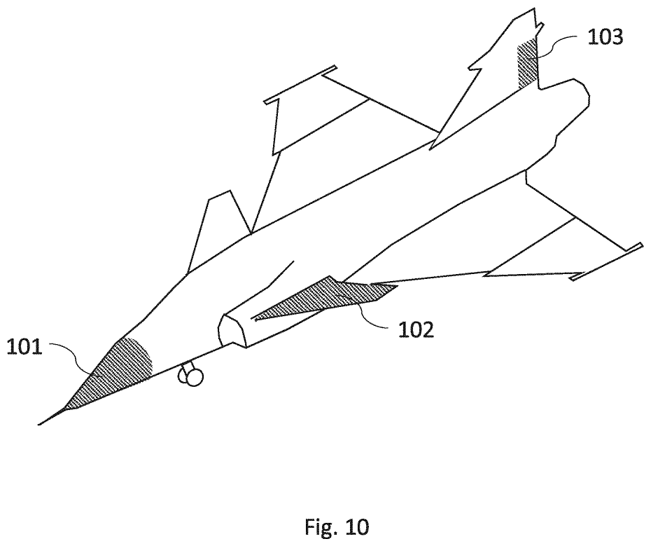

Reference is now made to FIGS. 9 and 10, which illustrate different applications of the thermo-acoustic generator systems of the present disclosure, to situations in which the noise is generated by the flow of air over parts of the moving object or inside ducts.

In FIG. 9, there are shown thermo-acoustic devices 90 applied to various selected areas of the external panels of a motor vehicle, in order to cancel the wind noise generated in the region of those selected areas. The regions from which the flow noise is generated are determined by means of preliminary wind tunnel investigations of the vehicle. Thermo-acoustic devices can also be applied along parts of the length of the exhaust pipe 91 of a motor vehicle, in order to compensate locally for the noise generated by the flow of the exhaust gases down the exhaust pipe.

In FIG. 10, there are shown thermo-acoustic devices applied to the nose cone 101, canard wings 102, and rudder 103 of a military aircraft, to reduce the flow noise generated by the air passing across these surfaces.

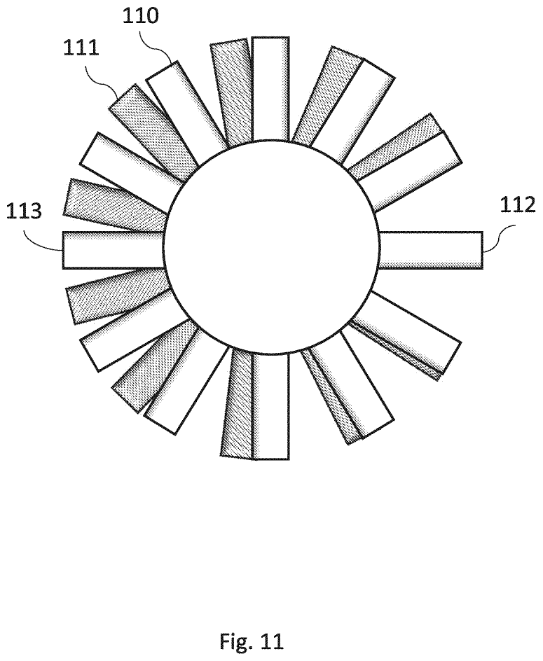

Reference is now made to FIG. 11, which illustrates a configuration for generating predictive noise cancellation in a turbojet engine, by evaluation of the relative rotor-stator phase angle. FIG. 11 shows a fan having twelve rotor blades 110, shown in FIG. 14 with cross-hatched lines, and eleven stator blades 111. The relative phase angle between the rotor and the stator blades is different for each angular blade position, because of the unequal numbers of blading. At the 3 o'clock position of the fan, 112, the rotor blade and the stator blade are at the same angular position. At the opposite, 9 o'clock position of the fan, 113, the rotor blade and the stator blade are in antiphase. The relative location of rotor blades with respect to stators at each point of time and the relative speed of rotation, enables prediction of the fundamental frequency and phase expected from each particular blade passage event, and hence, if desired for the most comprehensive noise cancellation, the noise field at each single stator position. This can be determined either from a prediction based on a previous simulation of generated noise, or can be based on previous measurements of actually generated noise levels. Alternatively, if a less accurate noise cancellation is desired, the predicted noise characteristics from separate sectors of the fan can be used by combining the noise expected from a number of blades, and using that noise profile for cancellation of the noise in that sector of the fan.

In order to predict the noise field arising from the varying flow at each single stator position, or any other aero-acoustic interaction, either previous measurements of actually generated noise levels or computational simulation tools can be used. Numerous mathematical approaches to simulating complex aero-acoustic interactions are known in the art. These range from computationally expensive Direct Navier Stokes solvers, to reduced hybrid models that combine two separate numerical approximations, first a dedicated Computational fluid dynamics (CFD) tool and secondly an acoustic solver. The initial flow field is solved via various CFD solvers. Both steady state (Reynolds Averaged Navier-Stokes, Stochastic Noise Generation and Radiation) and transient (Direct Navier-Stokes, Large Eddy Simulation, Detached Eddy Simulation, Unsteady Reynolds Averaged Navier-Stokes) fluid field solutions can be used. These results include the sources of aero-acoustic noise and thus serve as inputs to the second acoustic solver, which calculates the sound propagation. The sound propagation can be characterized via various methods such as Lighthill's analogy, Kirchhoff integral, Linearized Euler Equations and others.

FIG. 14 illustrates for the case of a rotation generated noise field, the application of a predictive construction of the noise field, rather than its measurement by microphones. However, a noise field originating from a linearly moving element can also be considered. For instance, the linear motion of the pistons of an internal combustion engine can be used as the reference motion in order to relate to, for instance, the exhaust noise from that engine, since the nature of the exhaust noise will be related to the position of the pistons, or any other measurable quantity synchronized thereto, such as the flywheel position. Similarly, the noise generated by a linear pump can be related to the position of the piston in the compression cylinder. The predictive determination of the noise field can therefore be performed either by acoustic simulation or by predetermined measurements, relating the noise spectrum and phase to the position of the linearly moving elements of the mechanism.

It is appreciated by persons skilled in the art that the present invention is not limited by what has been particularly shown and described hereinabove. Rather the scope of the present invention includes both combinations and sub-combinations of various features described hereinabove as well as variations and modifications thereto which would occur to a person of skill in the art upon reading the above description and which are not in the prior art.

1. A system for the reduction over a spatial volume, of a noise field arising from an aerodynamic interaction of an element having relative motion with its surrounding fluid, said system comprising:
at least one microphone disposed on said element or in close proximity thereto, said at least one microphone adapted to produce an output signal corresponding to the noise field arising from interaction of said element with its surrounding fluid;
at least one planar thermo-acoustic generator having an electrically powered heating layer, said thermo-acoustic generator being disposed on said element, or in close proximity thereto; and
a control unit adapted to utilize the output signal of said at least one microphone, and to generate current correlated to the output signal for application to the electrically powered heating layer, such that said at least one thermo-acoustic generator emits a compensating noise field having the frequencies and amplitudes of that measured by said at least one microphone, but having an opposite phase, such that said noise field is globally reduced over said spatial volume.

2. A system according to claim 1 wherein said relative motion arises either from motion of said element through said fluid, or from motion of said fluid past said element, or from a combination thereof.

3. A system according to claim 1, wherein said relative motion of said fluid with respect to said element is temporally or spatially non-uniform motion.

4. (canceled)

5. A system according to claim 1, wherein said element is at least one blade of a fan or a compressor or a turbine.

6-7. (canceled)

8. A system according to claim 1, wherein said at least one thermo-acoustic generator is disposed on at least one of the stator or the rotors of a fan or a compressor, or a turbine.

9-10. (canceled)

11. A system according to claim 1, wherein said at least one thermo-acoustic generator is disposed on at least one of the surfaces of a ground vehicle or an aerial vehicle.

12. (canceled)

13. A system according to claim 1, wherein said control unit is configured to spectrally analyze said noise field, and to generate from spectral components of said noise field, waveforms of current for applying to said at least one thermo-acoustic generator, having frequency, amplitude and phase such that the spectral components of said compensating noise field emitted by said thermo-acoustic generator neutralize said spectral components of said noise field.

14. A system for the reduction over a spatial volume, of a noise field arising from an aerodynamic interaction of an element having relative motion with its surrounding fluid, said system comprising:
at least one planar thermo-acoustic generator having an electrically powered heating layer, disposed on said element or in close proximity thereto; and
a control unit adapted to generate a current correlated to the noise field for application to the electrically powered heating layer, such that said at least one thermo-acoustic generator emits a compensating noise field having the frequencies and amplitudes of said noise field, but having opposite phase, such that said noise field is globally reduced over said spatial volume,
wherein said frequencies, amplitudes and phases of said noise field are predicted either by a simulation of said noise field as a function of the position and speed of motion of a moving element associated with the flow of said fluid, or by a set of prior measurements of said noise field as a function of the position and speed of motion of said moving element.

15. A system according to claim 14, wherein the motion of said moving element is either a rotation or displacement motion.

16-17. (canceled)

18. A system according to claim 14, wherein said moving element is at least one blade of a fan or a compressor or a turbine.

19-20. (canceled)

21. A system according to claim 14, wherein said at least one thermo-acoustic generator is disposed on at least one of the stator or rotor of a fan or a compressor or a turbine.

22. (canceled)

23. A system according to claim 14, wherein said at least one thermo-acoustic generator is disposed on at least one of the surfaces of a ground vehicle or an aerial vehicle.

24. (canceled)

25. A system according to claim 14, wherein said control unit is configured to spectrally analyze said predicted noise field, and to generate from spectral components of said predicted noise field, current waveforms for applying to said at least one thermo-acoustic generator, said current waveforms having frequency, amplitude and phase such that the spectral components of said compensating noise field emitted by said thermo-acoustic generator neutralize said spectral components of said predicted noise field.

26-28. (canceled)

29. A method for the reduction over a spatial volume, of a noise field arising from an aerodynamic interaction of an element having relative motion with its surrounding fluid, said method comprising:
providing at least one planar thermo-acoustic generator having an electrically powered heating layer, disposed on said element or in close proximity thereto; and
generating a current correlated to the noise field for application to the electrically powered heating layer, such that said at least one thermo-acoustic generator emits a compensating noise field having the frequencies and amplitudes of said noise field, but having opposite phase, such that said noise field is globally reduced over said spatial volume,
wherein said frequencies, amplitudes and phases of said noise field are either measured or are predicted by a simulation of said fluid flow as a function of the position and speed of motion of a moving element associated with the flow of said fluid.

30-31. (canceled)

32. A method according to claim 29, wherein said noise field is measured in real time by at least one microphone, said at least one microphone adapted to produce an output signal corresponding to the noise field arising from interaction of said element with its surrounding fluid;

33. A method according to claim 29, wherein said noise field is previously measured by at least one microphone, said at least one microphone adapted to produce an output signal corresponding to the noise field as a function of the position and speed of motion of said moving element.

34. A method according to claim 29, wherein said generated current is produced by a control unit configured to spectrally analyze said noise field, and to generate from spectral components of said noise field, waveforms of current for applying to said at least one thermo-acoustic generator, having frequency, amplitude and phase such that the spectral components of said compensating noise field emitted by said thermo-acoustic generator neutralize said spectral components of said noise field.

35. A system according to claim 1, wherein the motion of said moving element is either of rotation or displacement motion.

36. A system according to claim 14, wherein said relative motion arises either from motion of said element through said fluid, or from motion of said fluid past said element, or from a combination thereof.

37. A system according to claim 14, wherein said relative motion of said fluid with respect to said element is temporally or spatially non-uniform motion.
